(19) United States
(12) Patent Application Publication
(10) Pub. No.: US 2016/0070926 A1
(43) Pub. Date: Mar. 10, 2016

(54) METHOD AND APPARATUS FOR VARIABLE AND FEE BASED CONTENT RIGHTS AND PERMISSIONS

(71) Applicant: StoryCloud, Inc., San Diego, CA (US)

(72) Inventors: Kenneth J. KALB, Solana Beach, CA (US); Michael W. TRACY, Solana Beach, CA (US); Christina LIAO, San Diego, CA (US); Thomas H. BUSCHER, Los Angeles, CA (US)

(21) Appl. No.: 14/660,896

(22) Filed: Mar. 17, 2015

Related U.S. Application Data
(63) Continuation-in-part of application No. 14/531,776, filed on Nov. 3, 2014.
(60) Provisional application No. 62/047,619, filed on Sep. 8, 2014.

(51) Int. Cl. G06F 21/62; G06Q 20/12; H04L 29/06

(52) U.S. Cl. CPC G06F 21/6245; H04L 63/102; G06Q 20/1235

(57) ABSTRACT

The system provides a method and apparatus for defining rights and permissions for content that allows for subsequent modification of creator owned content, but restricted to permissions and changes associated with the content. The permissions may be one or more from a plurality of possible modifications, time periods, distribution rights, and the like, and include a fee associated with the right to modify. In one embodiment content is accessed via a dynamic link, and the dynamic link includes rules, controls, and restrictions that limit the ability to modify the content to an agreed upon number and type of changes.

This patent application is a continuation-in-part of U.S. patent application Ser. No. 14/531,776 filed on Nov. 3, 2014 which claims priority to U.S. Provisional Patent Application 62/047,619 filed Sep. 8, 2014, both of which are incorporated by reference herein in their entirety.

### BACKGROUND OF THE SYSTEM

Since the creation and widespread use of consumer based content reproduction technologies, content owners have faced tensions between making content easily available while at the same time making it difficult to copy and modify the content. In the field of audio content, consumer recording technologies have allowed consumers to make mix tapes, collect so-called “bootleg” versions of live and unreleased performances, and to even apply re-mixing techniques to content owned and produced by others.

In the arena of video content, the advent of the home video recorder allowed users to create their own libraries of video content, either by recording broadcasts, or by copying licensed content from rented or sold videos.

In the digital age, copying and modifying content has become even easier and correspondingly more problematic for content creators. The ease of copying content, the ability to store very large numbers of content files on storage devices, and the ability to match or nearly match the quality of the original content file has created a new era of concern for rights holders. One attempt to control the unauthorized copying of content is by including anti-copy protection software, digital rights management (DRM) software, and other protection features to prevent, or at least make more difficult, the copying and modification of content by users.

In spite of these safeguards, there remains a thriving marketplace for pirated or modified third party content. A popular technique of modifying content is referred to as a “mash-up” and consists of creating an audio and/or video composition comprised of two or more content sources. Such mash-ups have proven very popular and are often featured on video hosting sites such as youtube.com. Although there are procedures in place for removing copyrighted content, there nevertheless remains a huge demand for such creations.

Another use of content is the overlaying of graphical elements onto video content, to provide additional information about some aspect of the scene, or to represent a user reaction to the content, or for other purposes. In other examples, a user may want to replace or supplement the soundtrack to provide audio commentary about the content that plays back when others view the modified file.

Although entertaining, such modifications suffer from the disadvantage of being unauthorized, and the content owners are not compensated for the mash-ups and modified files.

### SUMMARY

The system provides a method and apparatus for defining rights and permissions for content that allows for subsequent modification of creator owned content, but restricted to permissions and changes associated with the content. The permissions may be one or more from a plurality of possible modifications, time periods, distribution rights, and the like, and include a fee associated with the right to modify. In one embodiment content is accessed via a dynamic link, and the dynamic link includes rules, controls, and restrictions that limit the ability to modify the content to an agreed upon number and type of changes. Because the original content is accessed only via dynamic link, the content creator can require compensation for the right to create modified works and has the ability to revoke the rights after an agreed upon period or upon misuse of the content. In one embodiment, the content is distributed via a private social network.

### BRIEF DESCRIPTION OF THE DRAWINGS

FIG. 1 is an example of a cloud of single purpose servers in an embodiment of the system.

FIG. 2 is an example of a single purpose server in an embodiment of the system.

FIGS. 3A-3D illustrate a mobile user interface in an embodiment of the system.

FIG. 4 is a flow diagram illustrating the creation of a PSN in an embodiment of the system.

FIG. 5 is a flow diagram illustrating the operation of the system in providing access to content via a link in one embodiment.

FIG. 6 illustrates an example of the sharing of content in one embodiment of the system.

FIG. 7 illustrates the display of a mobile device in one embodiment when content is accessed using the system.

FIG. 8 illustrates an embodiment of the system.

FIG. 9 illustrates an example computing environment of the system.

FIG. 10 is a flow diagram illustrating the selection of content and preparing it for use in an embodiment of the system.

FIG. 11 is a flow diagram illustrating the purchase of modifiable content in one embodiment of the system.

FIG. 12 is a flow diagram illustrating the modification of content in one embodiment of the system.

### DETAILED DESCRIPTION OF THE SYSTEM

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean serving as an example, instance, or illustration. Any embodiment described herein as “exemplary” is not necessarily to be construed as preferred or advantageous over other embodiments. Likewise, the term “aspect” of an apparatus, method or article of manufacture does not require that all embodiments of the invention include the described components, structure, features, functionality, processes, advantages, benefits, or modes of operation.

System Embodiment

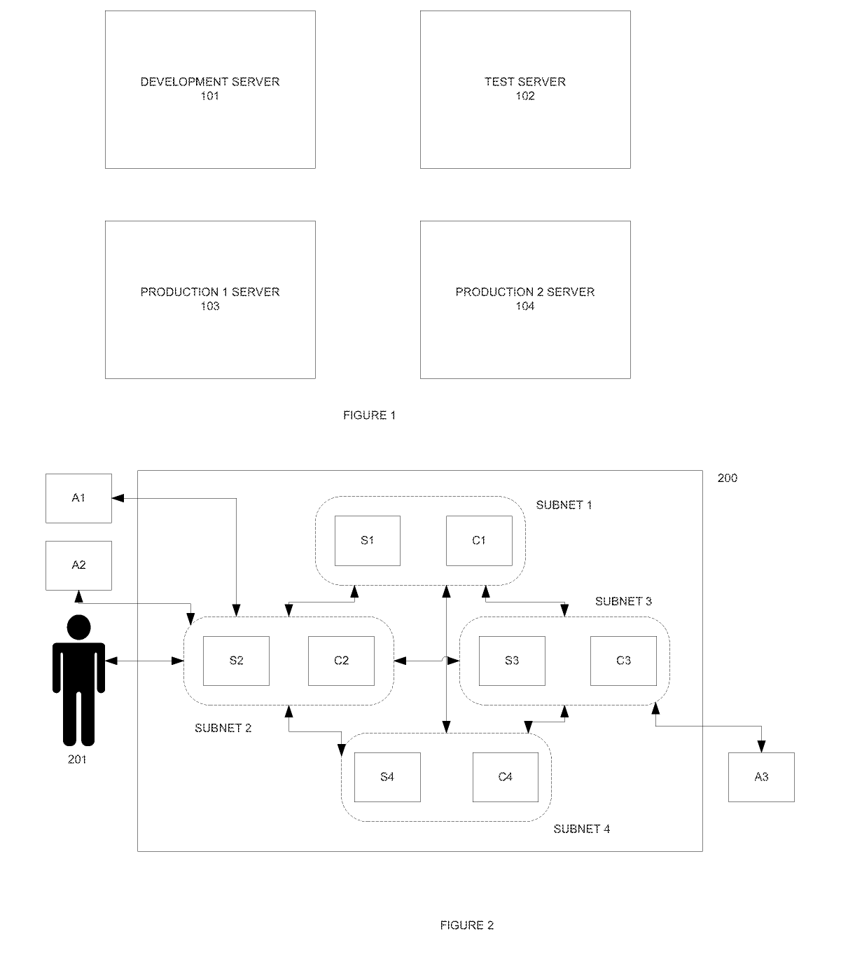

The system provides the ability for any user to easily create a private social network (PSN). A PSN may be a secure permission based social network. The system is implemented through a cloud server based architecture having components that are used in developing, testing, and producing a scalable number of PSNs. FIG. 1 is an example of one embodiment of the architecture of the system.

FIG. 1 shows a cluster of single purposes servers including Development server 101, Test server 102, Production 1 Server 103 and Production 2 Server 104. The servers are implemented in the cloud and can be accessed through a network such as the Internet. The system is scalable such that any number of single purpose servers can be instantiated to provide the necessary services and functions to support the creation and management of PSNs. Although not shown in FIG. 1, each of the single purpose servers can communicate with third party applications as needed.

Each server cluster is a self contained entity using, for example, the Apache Hadoop system for storage and large scale processing of big data. Each cluster is capable of running approximately 1,000 machines. The server clusters may be implemented in, for example a cloud service such as Amazon Web Service (AWS). Each server cluster is virtually cordoned off in their own network separate from the other servers in the AWS. The system in one embodiment uses Java to control the database, APIs, and function calls. Redis is a caching application that is used in one embodiment. The system is easily scalable because a new server cluster can be cloned from an existing server cluster in a matter of moments. The creation of new server clusters may be driven by volume or performance. For example, it may be more useful to clone a new server cluster in a geographic location closer to a user base, including crossing international borders to provide more responsive service.

FIG. 2 illustrates the architecture of one example single purpose server. The single purpose server 200 is comprised of a plurality of subnets (Subnet 1-Subnet 4). Each subnet comprises a plurality of services S and clusters C such as services S1 and clusters C1 in Subnet 1, services S2 and clusters C2 is Subnet 2, services S3 and clusters C3 in Subnet 3, and services S4 and clusters C4 in Subnet 4.

The single purpose server 200 can communicate with users and with third party applications such as applications A1, A2, and A3. In one embodiment, application A3 may be an application controlling a PSN created by the system and is therefore considered to be “within” the PSN system. Applications A1 and A2 may be third party applications that are “outside” the PSN system but yet have access to, or may be accessed by, users within the PSN system. The third party applications could be public social networks that interact with the server 200 or it may be a service application (e.g. Amazon S3) that is associated with managing the cloud environment. The clusters may be implemented as virtual clusters using virtual machines (VMs). The VM may run Java or some other bytecode enabled system. The user of virtual clusters allows more scalability and live migration of memory and files, and dynamic deployment of additional virtual clusters as needed.

Each single purpose server 200 provides services in each such as database, caching, load balancing, security, encryption, dynamic link control, web server control, and storage and large-scale processing of data sets on clusters (e.g. Apache Hadoop) and others. These services and components are accessed and invoked through a series of function calls through an API that allows the creation of a scalable number of private social networks. The function calls define what features will be present in a private social network. The dynamic link control allows the network to control read and write privileges, permissions and other accesses for who, what, when, for how long and on what device, a particular piece of content or service will be available.

Each of the Subnets 1-4 can communicate with any of the other Subnets. Communication extends to the Services and Clusters within each Subnet. In one embodiment, one Subnet may provide security functions, including encryption, validation, permissions, and the like. Another Subnet may provide performance related functions such as memory management, caching, database control and the like. Another Subnet may provide operational functions such as communication, applet operation, Internet interface, and the like. Another Subnet may provide the functions and functionality that run the PSN.

PSN Creation

The system provides a method and apparatus for creating a private social network using an application. The result is an autonomous social network where the creator becomes the owner and/or administrator. In one embodiment, the system is implemented via a mobile app on a smart-phone, pad computer, tablet computer, or any other mobile computing device. The system may also be implemented on a desktop computer. Once created, the private social network can be accessed by any of the authorized users/members on any computing device that can access a network such as the Internet or other suitable network.

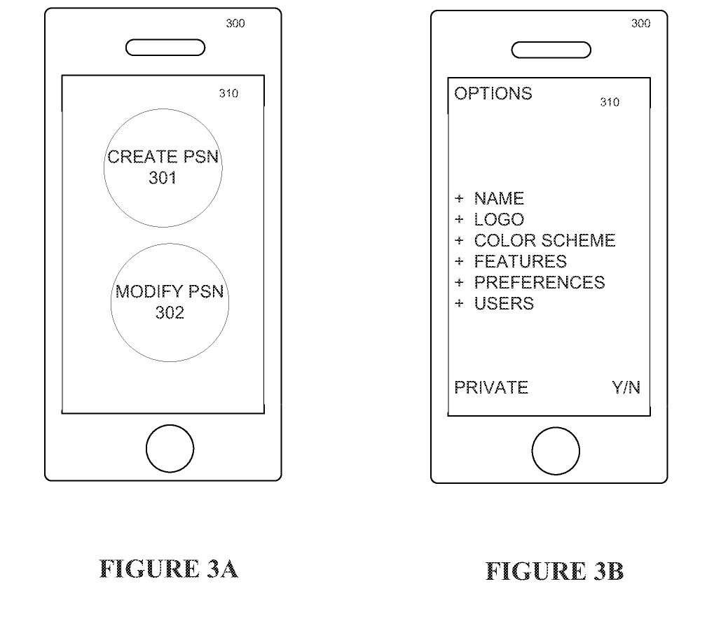

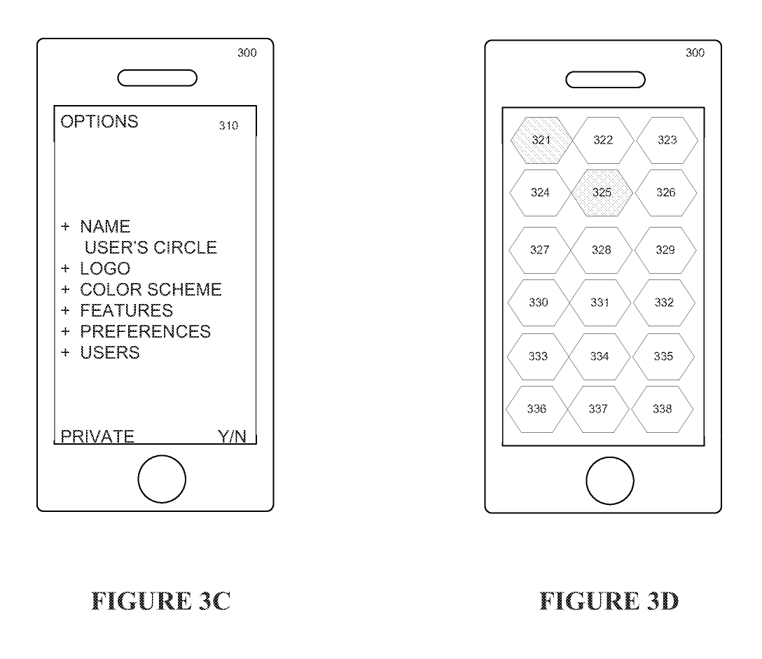

FIGS. 3A-3D illustrate an example of the user interface for the substantially immediate creation of a private social network on a mobile device in one embodiment of the system. The system allows a private social network to be built and ready for use in as little as 60 seconds. Referring first to FIG. 3A, a smart-phone 300 includes a display region 310 that is typically a touch sensitive screen so that user input may be detected and converted into some action by the device. After the application is invoked, the user is presented with a choice to create a PSN 301 or to modify an existing PSN 302 The system contemplates the ability to create, manage, and modify a plurality of PSNs.

When the user has selected Create PSN 301, the display changes to that of FIG. 3B. The display 310 now presents a plurality of options that the user will select to define different aspects of the PSN. In one embodiment, the system or the user may have pre-defined default selections for some or all of the parameters, while in other cases, the owner will go through all of the options when creating a PSN. In the example shown, the system presents options for Name, Logo, Color Scheme, Features, Preferences, and Users. There is also a way to make the social network private or not as desired. In practice, all of the networks created using the system can be considered to be private social networks in the sense that they are created individually by each user. However, the PSN may allow some limited and controlled public access to non-users as a way of inviting additional users or for other purposes.

In one embodiment, each of the options includes “+” next to its identifying term to indicate that the selection of an option will present additional choices. For example, if the owner selects “Name”, the display will change to that as shown in FIG. 3C. When Name is selected, a text box is opened below the Name option and a keyboard is presented to the user (or a physical keyboard may be used). In the example shown, the owner has named the new PSN “User's Circle”. Being able to name your PSN is an advantage over prior art social networks.

When the owner selects Features, the display changes to that shown in FIG. 3D. FIG. 3D illustrates a plurality of features 321-338 that can be selected by tapping on the respective feature shape. Although 18 features are illustrated, the number of features can be changed and can be on one or more pages as desired. When a feature is selected, the color, shading, or border of the feature changes to show the owner that the feature has been selected. As shown in FIG. 3D, features 321 and 324 have been selected. Examples of features can be as follows in Table 1

TABLE 1

| | | |
|---|---|---|
| PERMISSION 321 | STORAGE 322 | CALENDAR 323 |
| MAIL 324 | STORYLINE 325 | PUBLISHING 326 |
| SHARE 327 | MESSAGING 328 | PURCHASE 329 |
| ANALYTICS 330 | SETTINGS 331 | HISTORY 332 |
| EVENT/ | PROJECT | UPLOADER 335 |
| SCHEDULER 333 | LISTS 334 | |
| POLLS/ | CLASS/ | E-COMMERCE 338 |
| VOTING 336 | ACHIEVMENT 337 | |

These are given by way of example only, and other features may be presented without departing from the scope and spirit of the system. For example, the system can include features such ticketing, coupons, offers, advertisements, friending, following, and the like.

Permission 321 provides the ability to select the audience and the digital content as well as the location, time, date, duration, and device for when the content may be seen or consumed by a recipient. Storage 322 provides the ability to store PSN digital assets, to organize by tag of digital assets, and to organize by contributor/user. Calendar 323 is a shared calendar that can be used by the members of the PSN to identify events related to the group. Mail 324 provides a private and secure mail feature for the PSN, with the additional feature of being verified so that mail recipients can trust that the sender is a verified user. An example of the verified mail system is described in pending patent application Ser. No. 14/455,595 filed on Aug. 8, 2014.

Storyline 325 provides a member the ability to automatically build a narrative of activity associated with the member. The Storyline can be supplemented by other members via interaction with the member or by manually adding data to the Storyline of the member. Publishing 326 provides the ability to select, display and manage content to be published, currently published or previously published, as well as by source, destination, audience type, audience size, time, date, location and device. Share 327 provides the ability to share selected content immediately, at a specific time or date, a recurring time and date, a variable time and date or a randomized time and date.

Messaging 328 provides the ability for in-PSN messaging for the private social network. This feature can build an automatically populated messaging asset that can be used as an instant messenger or SMS type messaging system. Messaging 328 can be defined as 1 to 1 or group messaging. Purchase 329 provides the ability to handle financial transactions in the PSN. This activates a process that allows members to pay dues, donate to charity, handle financial transactions related to offers of sales to third parties, and the like. Analytics 330 provides real-time statistical data associated with the PSN, and may be tied to activities of the members, purchasing information, and other analytical information that can be used to qualify the performance of the PSN.

Settings 331 provides the ability to adjust a variety of parameters associated with the application including, but not limited to theme style, display name, tagline, tag identifiers, payment information, banking, credit or debit information deposits or withdrawals, account information, profile information, permissions, additional users, advertisement, marketing, list of users (active, passive), user management: approve, deny, invite, request, list of additional features or functions that can be added or subtracted from application. It is an instant, ad-hoc, user configurable social network. History 332 provides the ability to keep a history of activity, messaging, and other data associated with the PSN. Event/Scheduler 333 allows a member to send invitations to other members and includes an RSVP function and possibly offers (e.g. raffle tickets, attendance fee handling, and the like). Project Lists 334 provides the ability to define a set of tasks, goals, or other items that can be associated with one or more members and also tied into the calendar feature to establish deadlines.

Uploader 335 is a feature that is invoked if the PSN is to allow digital assets to be transferred to shared storage of the PSN. Polls/Voting 336 provides the ability to define and present question and response to group members and to tally the results. Class/Achievement 337 provides the ability to associate the class or status of a member of the group with the accomplishment of activities defined in the PSN. Such status may be reflected by the offering of status badges, levels, icons, or other indicators of classification associated with achievements. E-Commerce 338 provides the ability to accept payments for events, tickets, donations, location based access, media, products, and peer to peer money transfers; alternatively, enables user to pay other users and application administrators for the aforementioned items.

The Logo option allows the owner to select a graphic image that can be used as the logo for the PSN. This image may be from the owner's own image gallery, may be downloaded from a network, or may be a choice of logo's provided by the app and system.

The Color Scheme option presents the owner with a plurality of themes and color schemes that can be used with the PSN. In some cases, the owner can select a theme and then use a color picker to adjust colors of different aspects of the theme of the PSN.

The Preferences option presents various options for the owner to select for the operation of the PSN. For example, the owner may select preferences related to data presentation, sorting of posts, publishing options (including automatic publishing within and between other public and private social networks selected by the user, tying the PSN to other accounts, and other preferences).

The Users option is used by the owner to invite and/or validate members of the PSN. In one embodiment, the system can use a list of existing friends and connections of the owner in other system PSNs and/or other public or other social networks, address books, and the like.

The system allows an owner to create a PSN with only those features desired by the owner to be implemented in the PSN. For example, if the owner does not need the ability to purchase goods or services in the PSN, the user does not select the Purchase feature when creating the PSN. This gives great flexibility and adaptability to the owner in generating multiple PSNs. A PSN can be custom designed to fit its purpose in a way that is not possible in prior art social networks.

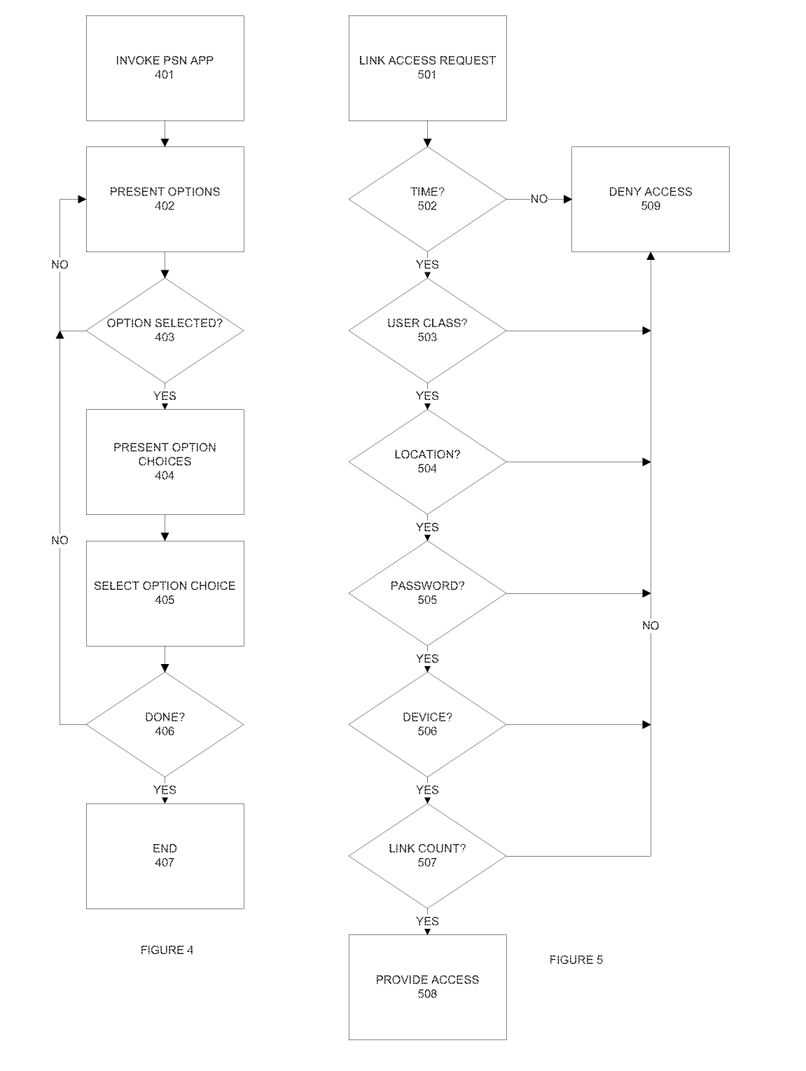

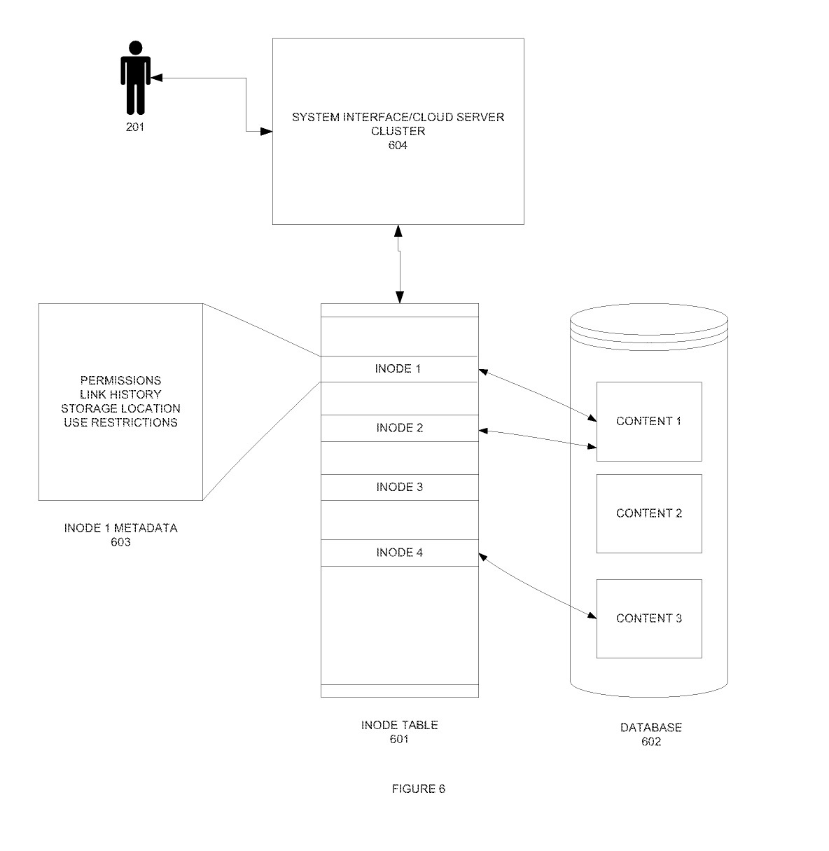

FIG. 4 is a flow diagram illustrating the generation of a PSN in one embodiment of the system. At step 401 an owner such as 201 in FIG. 2 invokes the Create PSN app on a computing device (e.g. a smart-phone). The invocation of the app on the computing device includes a connection to one or more of the single purpose servers in the cloud computing environment, such as server 200 of FIG. 2. In one embodiment, the selection of the options and features of the PSN takes place locally on the computing device and after all selections have been made, the build of the PSN takes place on the server 200.

At step 402 the system presents options to the user 201, such as those shown in FIG. 3B. At decision block 403 the system determines if an option has been selected. If not, the system returns to step 402. If so, the system presents the possible choices for the option at step 404. For example, if the owner has selected the Name option at step 403, the system shows a text field for entry of the name of the PSN as shown in FIG. 3C. If the owner has selected the Feature option at step 403, the system shows the Feature picker as shown in FIG. 3D.

At step 405, the owner makes a choice of the presented option (e.g. choosing a name or selecting one or more features, preferences, color schemes, selection of users, and the like). At decision block 406 it is determined if the owner is done creating the PSN. If so, the system ends at step 407. If not, the system returns to step 402.

In one embodiment, the features of the PSN are built locally on the owner's computing device and are then transmitted to the cloud where the PSN is formed based on the selections. In another embodiment, the owner's computing device is in connection with the cloud of servers and the PSN is built as the owner interacts with the PSN building application.

When a new PSN is built, the resources for running and managing the PSN are established in the cloud of single purpose servers and the PSN is available for user by the members of the PSN.

The ability to create and use PSNs provides use scenarios that are difficult or impossible to achieve using typical social media networks or existing tools. For example, a sports team can create a PSN just for their team. Team members can use the shared calendar and event scheduler to provide both passive and active notification of when and where the next game will be. The RSVP function helps confirm maximum participation.

A family can create a PSN just for the close family (e.g. parents and children). The family can coordinate their schedules, vacation plans, plays and other family events using the shared calendar and chat feature. Many children do not want their parents to be their “friends” on prior art social networks. A family PSN provides all the usefulness and tools of the social network without the perceived embarrassment of being online friends with a parent.

Controlled Data Access

In addition to the flexibility of creating a plurality of PSNs, the system includes additional protection for content that allows the owner of the content to determine and fully control who, what, where, and when/how long a content file is being shared. Whenever a member of a PSN links to content, they will have the ability to set granular controls, permissions, and limitations on the use and accessibility of the content or digital asset. In addition, the member can determine if the content will be sharable outside of a particular PSN, whether to other PSNs (e.g. application A3 of FIG. 1) or outside the PSN system (e.g. applications A1 or A2 of FIG. 1). Regardless of whether the content is to be shared within or without of the PSN system, the member can set limits to particular users, classes of users, or other access levels related to the content.

The content can be any digital asset including pictures, videos, documents, messages, and the like, and content can be accessible on devices, through the PSN, via the cloud, and the like.

The member of a PSN can set default options that may apply to all content that is created, with the member then adjusting settings as desired to provide more or less access to the content. Table 2 gives examples of the types of permissions that can be applied to content using the system.

TABLE 2

| | | | | |
|---|---|---|---|---|
| Start Time | End Time | Location | PSN Member | PSN System |
| | | | | Member |
| Link Count | Modify | Share Link | Analytics | Password |
| | File | | | Protect |
| Repeat | Event Tie-in | Outsider | Device Limits | Financial |
| Views | | | | |

The Start Time defines when the content will be available. This allows the user to set up permissions that will make content available in the future so that content can be scheduled in advance, without releasing the content. A link that is associated with the content will not operate if the Start Time has not yet occurred. The End Time defines when the access to the content will be terminated. The default for the Start Time may be that it is available upon uploading to the system and the End Time is open ended. The content owner is free to set any defaults for uploaded content. In one embodiment, the defaults may be tied to content type, with specific default profiles for text, audio files, video files, images, etc.

The Location setting may be used to set a geographical limitation on where the link to the content will be effective. For example, the content owner may only make the content link active at a specific location, such as a store, home, park, business, or the like. The system allows the owner to define a distance from a location in which the content link will be usable. The content owner may also limit access to the link to a PSN Member, a PSN system user, or it may be available to outsiders. The owner may require an outsider to register with the PSN system in order to be able to access the content link. In one embodiment, the content owner can access a map and use it to define a location at which content may be either viewable or prohibited, as desired. The user will also be able to use addresses, zip codes, or other location metadata to define protected geographical regions. Once a location has been determined, the content owner can use a slider or some other means to define the radius about which the content is available. In other embodiments, the user can define the region by drawing a boundary on the map, so that non-circular regions may be defined.

The Link Count can be used to set a number of times the link can be used to access the linked content. When the Link Count is exceeded, the link is rendered inactive. Repeat Views may be used to allow a user of the content link to use it more than once or to be limited to a single access. The Device Limits setting may be used to restrict access to the content link to a type of device either generically (e.g. a smart-phone), by producer (e.g. an Apple device), or even to restrict access to a single device, by tying access to a particular UDID or some other indicia that can be used to reliably identify a particular device. The link count can be bounded by number of impressions, unique views, particular user, time period, duration, and the like.

The content link may be password protected in that a person accessing the link will need to provide a password or respond to some other challenge before access to the link is given. The content owner can set the link to track and provide Analytics associated with use of the link, including identity of who accessed the link, how many times, for how long, and the like. The Share Link setting can be used to allow or restrict sharing of the link with others. If the link is sharable, all of the restrictions associated with the link stay with the link, so that protection is maintained.

The share link may be transmitted or communicated in any of a number of ways, including email, phone number, SMS, text, or any other suitable manner. The content

In some cases, the content owner may permit the user of the link to modify the content. This ability to modify the content may add another level of restrictions on who can modify, or it can apply to all users. The ability to modify can be parsed to one or more of a plurality of modification options, including overwriting, editing, adding audio, and the like.

The content link can have a connection to other events, such as a concert, sporting event, or other event, where the beginning and/or end of the event will define the accessibility of the content link. In one embodiment, the content link can have a financial component where a viewer may be required to pay for either viewing or to expand other permissions associated with the content link.

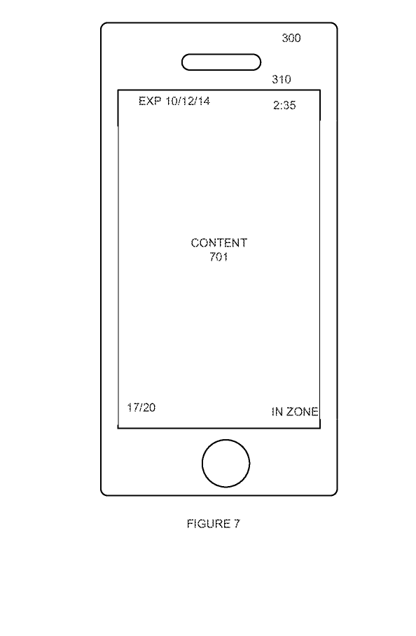

FIG. 5 is a flow diagram illustrating the operation of the system in providing access to content via a link in one embodiment. At step 501 someone makes a request to access the content link. At decision block 502 the system determines if the attempt to access the link is being made during the active time frame of the link. As noted above, this can be a fixed start and end period, or it may be tied to an event or some other time dependent trigger. If the access is not timely, the system denies access at step 509.

At decision block 503 the system determines if the user attempting access is in the approved user class as determined by the creator of the link. If so, the system proceeds, if not, access is denied. At decision block 504 it is determined if there is a location restriction and if so, if the user is within the designated geographic location for accessing the link. This may be determined by geo-location information provided by the access device of the user (e.g. smart-phone). At decision block 505, if there is a password requirement, the system requests it and checks for the proper password. If the password is not correct, the system may provide a certain number of retries. If the user fails to provide the password, access is denied.

At decision block 506 it is determined if there is a device requirement for access, and if so, whether the user is accessing the link on the correct device. This can be determined by IP address, UDID, MAC address, or some other reliable indicator of the device being used. At decision block 507 it is determined if the access request is within the number of allowed link requests. This number may be on a per-user limit or a total access limit for the link, as defined by the creator of the link. If the decision blocks are not satisfied, access is denied. If all are satisfied, the system provides access to the link at step 508.

When the viewer has access to the content, there are still restrictions associated with the content. The content is shared via the link, and is not resident on the viewer's device. Screenshot capability on the device is disabled to prevent the content from being captured by the device. Saving and forwarding the content is prohibited, although forwarding the link may be permitted. In some cases, the content may be modifiable by the user, depending on the permissions set by the content owner. In addition, the files will typically be encrypted to further provide protection.

The system allows the owner of content to have many levels of control and management over the content. By requiring all content to be accessed by link, the system allows a content owner to permanently remove content by eliminating the link to the content. This allows someone who posts a regrettable piece of content (unflattering picture, controversial post, and the like) to remove that content so that it is no longer accessible. This has advantages for content owners who want to sanitize their youthful exuberance and to present a more responsible face to employers, friends, relationships, and the like.

In one embodiment, the system implements the content links via and index node, referred to as an inode. The inode is a data structure that is used to represent an object (which can be any type of digital content). The inode includes attributes which can be used to characterize access to the referenced object, including access permissions, manipulation controls, and other content management metadata.

It is possible to have a plurality of inodes pointing to the same underlying data file (content). This allows the content owner to further customize access and manipulation possibilities of the underlying content. The content may be stored in “collection groups”. A particular content or resource may be found in more than one collection group.

FIG. 6 illustrates an example of the sharing of content in one embodiment of the system. A user 201 attempts to access a content link by communicating in the system through a system interface (e.g. PSN) at system interface/cloud server cluster 604. The server cluster 604 includes an inode table 601 that stores a plurality of links/inodes such as inodes 1-4. A database 602 is coupled to the link table and stores a plurality of content, such as Content 1, Content 2, and Content 3.

Inode 1 is illustrated in more detail in inode 1 metadata block 603. An inode includes permissions, link history, storage location of the content, use restrictions, and other metadata and control information that can be used by the content creator as described above.

As shown in FIG. 6, a particular content may be associated with one or more inodes. For example, Content 1 is associated with inode 1 and inode 2. Each inode can have its own associated permissions, access rules, modification rules, and the like. The content owner can create as many links or inodes to the same piece of content as desired, with each one being customized accordingly.

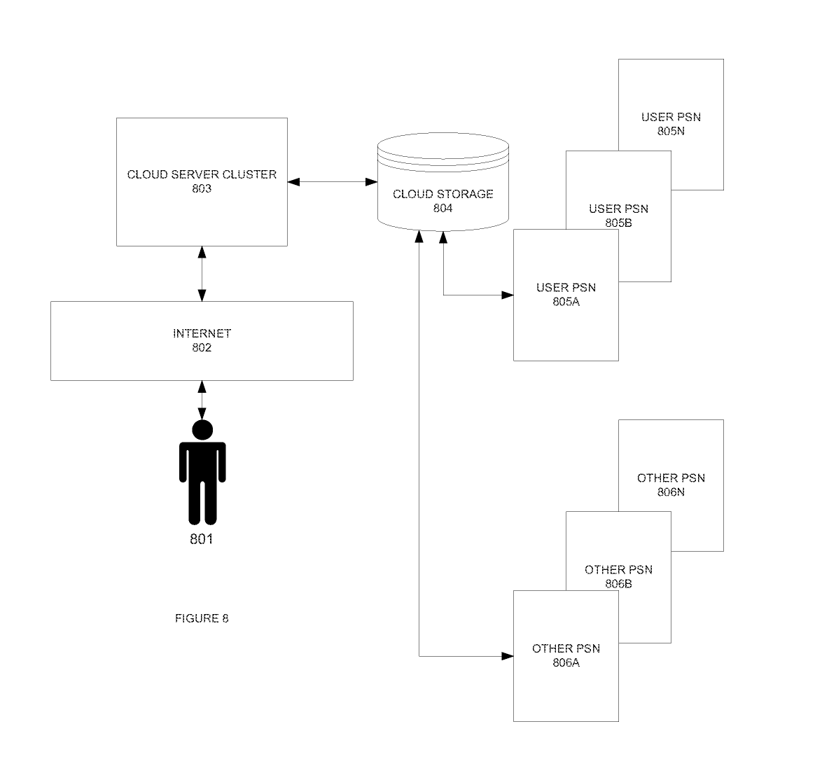

FIG. 7 illustrates the display of a mobile device in one embodiment when content is accessed using the system. The mobile device 300 displays the content 701 on the display 301. The content can be image, video, audio, document and the like. On the top left of the display 301 the system displays the expiration date (if any) of the content. The top right illustrates a countdown timer to show how much longer the content 701 may be viewed. This timer may refer to a current viewing session, an overall time limit associated with the content, an overall time limit associated with this particular viewer, and the like.

In the lower left of display 301, the system may display the number of views used and the total number of views available (e.g. this is the 17^{th} view out of 20 available). This may refer to the content for any user or it may refer to the content for this particular user. The lower right corner can be used to indicate if the user is in our out of the geo-location required (if any) for viewing the content. This is based on the device location and may or may not be a restriction, depending on the content owner.

Account Management

In one embodiment of the system, a user creates an account with the system and then can create multiple PSNs as desired. When the user invites members to a PSN, the system determines if the invited user is system member. If so, it can provide access to the PSN. If not, the system offers the opportunity to register in the system to the invited user and, after registering, the invited user becomes a member of the PSN.

An account may be family based, with a primary user and the right for other family members to create sub-accounts, or a specific number of PSNs. The system contemplates tiered pricing structures for various configurations, including number of PSNs, number of users, number of PSN members, and the like.

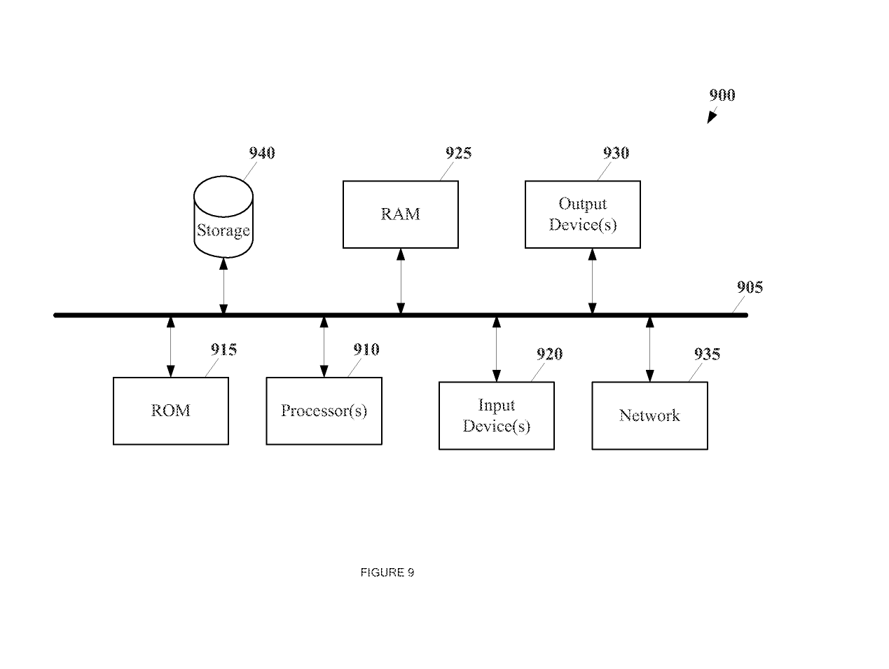

FIG. 8 illustrates an embodiment of the system. A user 801 accesses the cloud server cluster 803 via a network such as Internet 802. The cloud server cluster 803 interacts with cloud storage 804 where data for the PSNs created and managed by user 801 are stored. There may be a plurality of PSNs 805A, 805B, through 805N, depending on how many PSNs the user has created. The user 801 can also interact with other PSNs of which the user 801 may be a member, such as PSN 806A, 806B, through 806N.

Content Rights and Permissions

The system permits the distribution of content that can be manipulated by the user with overlays, mash-ups, added audio, re-cutting and the like. The content is accessed via a dynamic link such as the inode implementation described above. The inode is defined with attributes that control the amount of manipulation that can be practiced on the underlying content. The attributes described above, including who may access the content, for how long, where, and how often the content may be accessed are typically included along with the content manipulation attributes.

By providing licensed copies of content along with the ability to perform manipulations, the system creates a market for content that was non-existent or limited, allowing content creators and owners to receive compensation for manipulated version of the content. The system also allows the content to be parsed in a plurality of ways as desired. For example, consider a motion picture with multiple actors. The system could allow the content to be parsed to include only scenes including one or more of the actors. Similarly, the content could be parsed to only include scenes at a location or any other defining limitation.

Table 3 illustrates an example of the attributes that can be associated with content for use with the system.

TABLE 3

| | | | | |
|---|---|---|---|---|
| Start Time | End Time | Location | PSN Member | PSN System |
| | | | | Member |
| Link Count | Modify | Share Link | Analytics | Password |
| | File | | | Protect |
| Repeat | Event Tie-in | Outsider | Device Limits | Financial |
| Views | | | | |
| Overlay | Audio | Audio | Insert | Reconfigure |
| | Replacement | Overlay | | |
| Sort By | Delete | Share View | CGI | Filters |

The first three rows of Table 3 include the attributes described above in connection with Table 2 and have similar functionality here. The fourth row et seq. describes attributes associated with the content manipulation system. The attributes can be set to ON or OFF as well as include modifiers that relate to the attributes and the permissions for using them. Each of the content modification attributes may have an associated price so that a user can select and pay for the mashing attributes that are of interest.

The Overlay attribute allows the user to add elements on top of video content, including text, graphics arrows, icons, links, and the like. The Audio Replacement attribute provides the ability to replace the soundtrack of the content with another soundtrack. The Audio Overlay attribute allows the user to add one or more audio tracks to the existing soundtrack, and to modify the volume of each track. This may be useful for commenting on the content or any other suitable use. The Insert attribute permits the insertion of additional audio/visual content into the stream of the original content, such as added clips, still images, links, and the like.

The Reconfigure attribute permits the user to reorder clips in the original content, such as, for example, re-ordering scenes or even portions of scenes. The Sort By attribute allows the user to sort the content for clips and portions that relate to certain metadata associated with the content, such as actor, character, type of scene, and the like. The Delete attribute allows the user to delete some portion of the content. The Share View attribute allows the user to share access to modified content that the user might have created, without permitting any of the permissions of the original user. This suggests a “view only” sharing capability.

The CGI attribute allows the user to modify portions of the content by substituting in CGI created content. Such as replacing one character with another, or adding some other CGI artefact into the content. The Filters attribute permits the user to apply filters to the content, such as sepia tone, black/white, and other image filters to modify the look of the content as it is displayed.

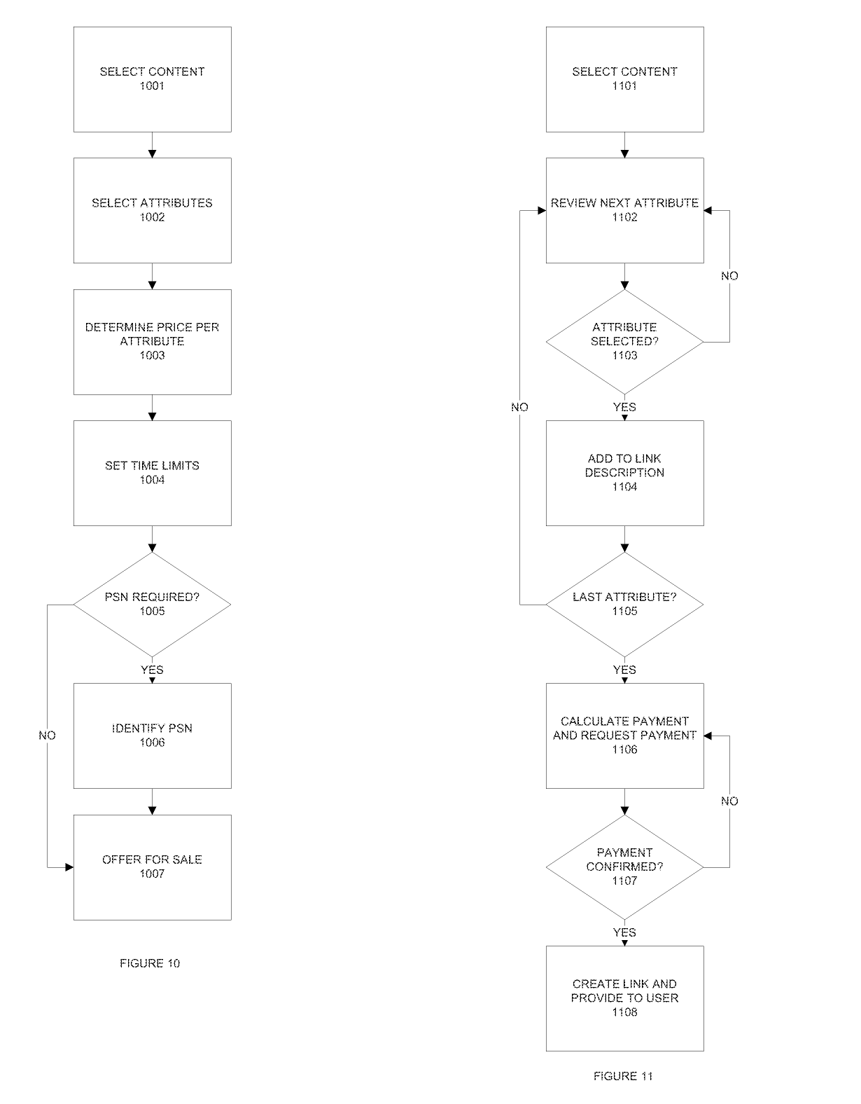

FIG. 10 is a flow diagram illustrating the selection of content and preparing it for use. At step 1001 the content owner selects content to be made available for modification. At step 1002 the owner selects the attributes that will be available to the user. It should be noted that even though the owner may offer all of the attributes to be available, it is contemplated that each attribute will have an associated price and the user may determine to only purchase some of the attributes at the time of transaction. In other instances, an owner may determine that some attributes will not be offered at all, and the user may not select those unselected attributes. Note that the attributes may each have an associated count of number of uses, or the attributes may be used freely without limit.

At step 1003 the content owner selects a price for each attribute. The price may be a per-use price, a fixed price for unlimited uses during the time period of use of the content, a scaled price structure based on use, or any other suitable pricing structure. If the pricing is for a certain number of uses of the attribute, it may be possible to purchase additional uses during the time the link to the content is active. Each attribute can have its own pricing structure as desired.

At step 1004 the content owner sets the time limit for the dynamic link that will be associated with the content. The content owner may only desire to have the content available for modification for a certain time period, choosing to control demand by controlling availability. At decision block 1005 it is determined if the content is available only to PSN members. If so the content owner identifies the appropriate PSN or PSNs at step 1006. After step 1006, or if there is no PSN requirement at step 1005, the system offers the content for sale at step 1007.

FIG. 11 is a flow diagram illustrating the acquisition of the content by a user for creating modified content. At step 1101 the user selects content that the user wishes to be able to modify. The selection of this content is through a PSN in one embodiment of the system. If there is a PSN requirement as at step 1005 of FIG. 10, then the user must access the content through the designated PSN. This requires the user to be a member of the PSN that has been identified and associated with the content. At step 1102 the system determines which of all possible attributes are available for the user and begins presenting each attribute to the user. The system presents the user with the attribute, a description of the functionality of the attribute, the price of the attribute and the time limit or use limit, if any, of the attribute.

At decision block 1103 it is determined if the attribute has been selected by the user. If not, the system returns to step 1102 and presents the next attribute. If the attribute has been selected, the system advances to step 1104 and adds the attribute to the dynamic link metadata that will be associated with the link to the content when completed.

At decision block 1105 it is determined if the most recent attribute was the last attribute to be presented. If not, the system returns to step 1102 and presents the next attribute. If it is the last attribute the system proceeds to step 1106. Here the system determines the total cost for the attributes (and underlying content) that have been selected by the user and requests payment. At decision block 1107 it is determined if the payment has been confirmed. If not, the system returns to step 1106.

If the payment has been confirmed, the system proceeds to step 1108. At this step the system constructs the dynamic link and provides it to the user. At this point the user is able to make modified mash-ups from the original content.

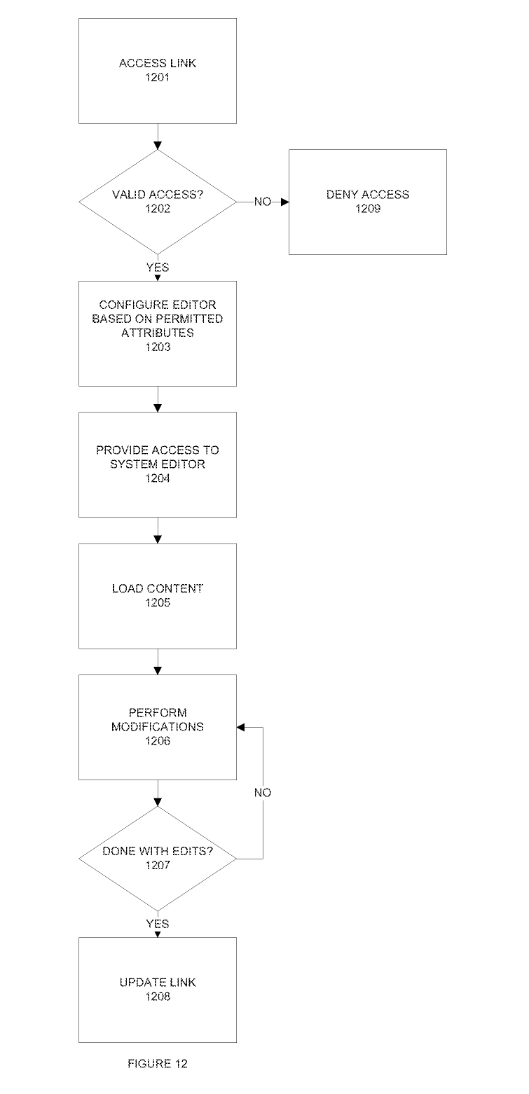

FIG. 12 is a flow diagram illustrating the modification of content in one embodiment of the system. At step 1201 the user attempts to access the link to the purchased content. As noted above, the access of the content may be required to be done via a PSN that has been established by the content owner. At step 1202 the system determines if the access request is valid. This may entail, for example, performing the steps described with respect to FIG. 5 or with some other method of confirming that the user has the right to access the link. If the access request is not valid, the access request is denied at step 1209.

If the access request is valid, the system proceeds to step 1203. In one embodiment, the system contemplates that the user will access the content via a player/editor located on the system, and not on data resident on the users computing device. At step 1203 the system player/editor is configured based on the attributes and metadata associated with the link of the user. For example, if overlay is not a purchased attribute (or if the content owner did not make overlay available) the system will disable that function on the system player. After the player has been appropriately configured, the system provides access to the player at step 1204 and loads the associated content at step 1205.

At step 1206 the user then can begin making edits and modifications to the content, as permitted by the selected attributes. The system checks periodically to determine if the user is done with the editing and modification at decision block 1207. If not, the system returns to step 1206. If so, the system proceeds to step 1208 where the content is saved to the system and the dynamic link is updated to account for any use limits based on count, to update any additional fee requirements that may be needed, and the like.

If the content includes the ability to share the link, the user can then provide the link to friends or otherwise make it available so that others can view the modified content. Because the modified content resides in the system and is view only to others, the risk of loss of the content is minimized and the content owner is able to generate new revenue from content than would have been possible before.

In one embodiment, the ability to share modified content is limited to users in the same PSN as the user that has modified the content. In this situation, the user can allow others to join the PSN and in that manner share the dynamic link to the modified content.

In another embodiment, the ability to access content and to modify it may be limited to a physical location. An example of a physical based system is described in U.S. patent application Ser. No. 14/515,393, filed on Oct. 15, 2014 and is incorporated by reference herein in its entirety.

In one embodiment, the process receives a geographic location of a mobile device. The process then provides content available for access by the mobile device based on the geographic location of the device. The content may have geographic constraints relating to the proximity of the device to a geographic location associated with the mobile content. For instance, the content broadcast service may have a default setting that only allows users located within a 5 mile radius of a location associated with a content to access the content. However, in some aspects of the content broadcast service, limiting access may be a customizable option with several different options. In such aspects, the content broadcasting service may limit access to only a particular behavioral patterns or a specified time frame. Particularly, the content may only be accessible user during a specified time frame. Users of the content broadcast service within geographic range of the content may be incapable of accessing the outside of the specified time frame. In some aspects of the content broadcast service, a visual representation of the content may be displayed, but when the user attempts to access the content, a message may appear indicating that the content is not yet, or no longer, accessible. In other aspects of the content broadcast service, a visual representation of the content may only appear during the specified time frame. Additionally, access to the content may be limited to devices that have first performed certain specified actions (e.g. behavioral patterns).

The process receives a selection of content to access from the mobile device. In some aspects of the content broadcast service, accessing the content may include viewing or manipulating the content. The process provides the content to the mobile device. For instance, the process may provide a temporary instance video or image to the device for viewing on the device. The mobile device may only access the content through the content broadcasting service. Particularly, the content is not permanently stored on the mobile device or accessible when the device is communicating with the content broadcasting service. Once content is provided to the mobile device, the process 300 ends.

Example Computer System

FIG. 9 illustrates an exemplary computer system 900 that may implement the access controller and/or the access control device. The computer system includes various types of computer readable media and interfaces. The system includes a bus 905, processors 910, read only memory (ROM) 915, input device(s) 920, random access memory 925), output device(s) 930, a network component 935, and a permanent storage device 940.

The bus 905 the communicatively connects the internal devices and/or components of the computer system. For instance, the bus 905 communicatively connects the processor(s) 910 with the ROM 915, the RAM 925, and the permanent storage 940. The processor(s) 910 retrieve instructions from the memory units to execute processes of the invention.

The ROM 915 stores static instructions needed by the processor(s) 910 and other components of the computer system. The ROM may store the instructions necessary for the processor to execute the web server, web application, or other web services. The permanent storage 940 is a non-volatile memory that stores instructions and data when the computer system 900 is on or off. The permanent storage 940 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 125 is a volatile read/write memory. The RAM 925 stores instructions needed by the processor(s) 90 at runtime. The bus 905 also connects input and output devices 920 and 930. The input devices enable the user to communicate information and select commands to the computer system. The input devices 920 may be a keyboard or a pointing device such as a mouse. The input devices 920 may also be a touch screen display capable of receiving touch interactions. The output device(s) 930 display images generated by the computer system. The output devices may include printers or display devices such as monitors.

The bus 905 also couples the computer system to a network 935. The computer system may be part of a local area network (LAN), a wide area network (WAN), the Internet, or an Intranet by using a network interface. The web service may be provided to the user through a web client, which receives information transmitted on the network 935 by the computer system 100.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

What is claimed is:

1. A method of distributing content comprising:
enabling one or more attributes of a plurality of attributes associated with a content, wherein each attribute represents a way to modify the content;
allowing a user to select one or more selected attributes of the enabled attributes;
generating a dynamic link to the content, where the dynamic link includes permissions based on the selected attributes;
providing the dynamic link to the user.

2. The method of claim 1 further including setting a price of each enabled attribute and charging the sum of the prices of the selected attributes.

3. The method of claim 1 wherein each enabled attribute has an associated time period of use.

4. The method of claim 1 wherein the dynamic link is accessed through a private social network.

5. The method of claim 1 wherein accessing the dynamic link allows the user to modify the content based on the selected attributes.

6. The method of claim 5 wherein a content player is configured for the content such that only the selected attributes are available for use.

7. The method of claim 6 wherein the user modifies the content using the configured content player.

8. The method of claim 7 wherein the modified content is saved and associated with the dynamic link.
